(19) United States
(12) Patent Application Publication
(10) Pub. No.: US 2013/0339116 A1
(43) Pub. Date: Dec. 19, 2013

(54) SYSTEM AND METHOD FOR A TRANSACTION SYSTEM

(71) Applicant: LEAF HOLDINGS, INC., Cambridge, MA (US)

(72) Inventors: Aron SCHWARZKOPF, Boston, MA (US); Sebastian CASTRO, Boston, MA (US)

(21) Appl. No.: 13/793,753

(22) Filed: Mar. 11, 2013

Related U.S. Application Data
(60) Provisional application No. 61/660,186, filed on Jun. 15, 2012.

(51) Int. Cl. G06Q 40/00

(52) U.S. Cl. CPC G06Q 40/00
USPC 705/14.23; 705/39; 705/14.27

(57) ABSTRACT

Systems and methods for determining transaction information for a purchase are provided. A system for determining transaction information for a purchase includes a processor having a user account module configured to receive order information associated with a user account. The order information is associated with a purchase and is received via the user account. The system also includes a payment module configured to receive payment information. The payment information does not identify the purchase, and does not identify the user account. The system also includes a token management module configured to determine that the payment information is associated with the purchase, and to determine transaction information associated with the purchase based on the order information and based on the payment information. The user account module is further configured to transmit at least a portion of the transaction information to the user account.

### CROSS REFERENCE TO RELATED APPLICATIONS

This application claims priority to and the benefit of U.S. Provisional Application No. 61/660,186, filed Jun. 15, 2012, entitled, “APPARATUS AND METHODS OF A TRANSACTION SYSTEM” the disclosure of which is hereby incorporated by reference in its entirety.

### BACKGROUND

The retail industry is highly competitive and often survival depends on providing customers with the utmost quality of service in an efficient and effective way. Ensuring that orders are placed correctly and that billing is handled precisely and conveniently is essential to promoting customer satisfaction and increase brand loyalty.

The retail industry predominantly uses point-of-sale (POS) terminals or devices for processing customer payments for goods, such as a credit card reader. In a typical transaction, a customer “checks out” at a retail store, where a salesperson scans the merchandise to determine an amount of the transaction. Then, the salesperson scans or enters payment information (e.g. a credit card number) provided by the customer, via a magnetic card reader of the POS device, for example. Since the order and purchase in this case occur at the same physical location and via the same interface, the merchant may be able to provide the order and payment information (collectively, the transaction information) to the customer once the payment is processed, in the form of one or more receipts, for example. In some cases, the order is processed by the salesperson with one system (e.g., a conventional cash register), and the payment transaction is processed with a completely separate system. Even though the order and purchase occur at the same physical location, the separate systems do not allow the merchant to match the detailed transaction information to the payment information.

There is hence a need to allow retailers and other merchants to provide complete transaction information (such as an itemized payment receipt) to customers, irrespective of how and where the order is placed, irrespective of what the order information constitutes, and while permitting the merchants to continue using existing POS devices.

### SUMMARY

Systems and methods of a transaction system are described herein. In some embodiments, a method of determining transaction information for a purchase includes receiving order information associated with a user account, where the order information is associated with the purchase. The method also includes receiving payment information. The payment information does not identify the purchase, and does not identify the user account. The method also includes determining that the payment information is associated with the purchase, and determining transaction information associated with the purchase based on the order information and based on the payment information. The method further includes transmitting at least a portion of the transaction information to the user account.

In some embodiments, a system for determining transaction information for a purchase includes a processor. The processor further includes a user account module configured to receive order information associated with a user account, where the order information associated with the purchase. The processor also includes a payment module configured to receive payment information. The payment information does not identify the purchase, and does not identify the user account. The processor further includes a token management module configured to determine that the payment information is associated with the purchase, and to determine transaction information associated with the purchase based on the order information and based on the payment information. The user account module is further configured to transmit at least a portion of the transaction information to the user account.

### BRIEF DESCRIPTION OF THE DRAWINGS

FIG. 1 is a system for determining transaction information for a purchase, according to an embodiment.

FIG. 2 is a schematic illustration of the payment system of FIG. 1, according to an embodiment.

FIG. 3 is a schematic illustration of the receipt system of FIG. 1, according to an embodiment.

FIG. 4 is a method of determining transaction information for a purchase, according to an embodiment.

### DETAILED DESCRIPTION

With the advent of e-marketing and social media marketing, it is increasingly desirable for merchants to be able to process payment for orders that are placed by the customer through such media, while still accepting payment at a POS device. For example, the customer might accept, via a social networking account of the customer, a (limited availability) food merchant's offer for a lunch special that expires at 2 pm, and expect to only pay the special price when he/she picks up the food order at the merchant's location, prior to 2 pm. Using current POS devices, while the merchant may process the payment for the lunch special, the merchant is unable to link the offer and the payment to provide a single, itemized receipt. At best, the merchant can provide a copy of the payment information to the customer, which does not list the offer. Further, the merchant is only able to provide this limited payment information to the customer where it is generated, whereas the customer may prefer to receive a complete receipt at the order location/device. Using the same example as above, the customer may prefer that the receipt be received and displayed on the customer's social networking account, to indicate that the customer availed of the specific food special (order information) by the food merchant for the special payment price (payment information).

Providing complete transaction information in such a scenario is a challenge because, to protect sensitive payment information such as credit card numbers, POS device are usually legacy devices that are tightly integrated with the backend payment processing system to provide a secure transaction environment. In other words, the payment processing system only accepts and processes POS-generated payment information, not merchant-generated order information.

One approach might be to modify the POS device and payment system to accept limited order information. Such an approach compromises payment security by allowing merchants to send third party data (i.e. not generated by the tightly controlled POS device) to the payment system. Additionally, such an approach limits the specification of order information by merchants. Further, such an approach requires a complete replacement of all existing POS devices owned by the merchant with the modified POS devices, an expensive proposition. Embodiments described herein provide a system and method that allows detailed transaction information to be paired with payment information such that, for example, an itemized receipt can be provide to a customer and/or a social media account at their direction without compromising the security of the payment system and without costly replacement and/or upgrades to existing transaction and payment systems.

As used in this specification, the singular forms “a,” “an” and “the” include plural referents unless the context clearly dictates otherwise. Thus, for example, the term “a network” is intended to mean a single network or a combination of networks.

Systems and methods for determining transaction information for a purchase from separately received order information and payment information are described herein. In some embodiments, the payment information does not include information about the purchase. Accordingly, the order information and the payment information are matched, combined, aggregated, and/or otherwise interlinked to generate transaction information. In some embodiments, discount information is applied to the transaction information. At least a portion of the generated transaction information can be communicated to one or more user accounts, as a paperless receipt for example. Aspects of this disclosure hence enable customers (also interchangeably referred to as ‘users’) to receive paperless receipts and/or discounts for orders placed at a separate location and time from the payment location, such as via a social media account of the user, for example. Aspects of this disclosure are further operable to permit merchants to continue using existing PoS systems that accept limited payment information, while still providing paperless receipts and/or discounts based on a user account that is not specified in the payment information.

Accordingly, embodiments described herein not only permit recognition of payments for separately placed orders, but also permit user to benefit therefrom by doing nothing more than paying for the separately and previously placed order by standard means, such as by simply swiping their credit card at a PoS of the merchant as is standard practice, for example. This approach also cures deficiencies of other systems/methods that require a user to produce additional identification (e.g. a merchant loyalty card, or a telephone number) to avail of benefits resulting from the purchase.

In some embodiments, certain features described herein are triggered by payment information received towards a purchase. In other words, no action is taken when order information is received, whereas receiving payment information results in determining whether order information exists that is associated with the payment information. In some embodiments, it is receipt of the order information that results in determining whether associated payment information exists. In this manner, the timing and order of receipt of the order information and the payment information can be accounted for.

Referring to the order information, in some embodiments, the order information is associated with a purchase by a user, and can specify the purchase. The term ‘purchase’ can refer to a specification of the entity being transacted for, and can include, but is not limited to, products, goods, services, and/or the like. In some embodiments, the order information is associated with a user account of the user, and can specify the user account. The user account can be any suitably unique identification of the user, such as, but not limited to, an email account, a phone number, an online account such as a social media account, and/or the like. In some embodiments, the order information is received via the user account; for example, when the user claims an offer advertised by a merchant on a social media profile of the user, or when the user places an order through an online marketplace where the user is registered via the first user account. Accordingly, it is understood that the term order can include an offer for the purchase that is posted by a merchant and ‘claimed’ by the user in a non-committal manner, where the user receives the purchase only upon actual payment at a later time.

In some embodiments, the order information can also include one or more of the following: images, videos, advertisements, tax information, a staff member of the merchant who places the order, any applicable discounts, an order amount, a location identifier for where the order is placed, a timestamp of the order, user information, merchant information, and/or the like.

In some embodiments, the order information can include a unique order identifier. Alternatively, the order identifier can be generated based on the received order information. The unique identifier can be in any suitable character format, including alphabetical, numerical, alphanumeric, binary, or the like. In some embodiments, the order identifier of the order can generated as a function of one or more of: a prepaid/gift/credit/debit card number, an email address, a cell phone number, social media credentials, a Near Field Communications (NFC) identifier, an order amount, a location identifier for where the order is placed, a timestamp of the order, an identifier provided by the customer, an identifier generated and/or provided by a system where the order is placed, and/or the like. In some embodiments, the order identifier can be the same as, or generated based on, the combination of an order amount, an order location, and an order timestamp.

In some embodiments, the order identifier is generated in a manner similar to the generation of a unique identifier of the payment (“payment identifier”), as described below. In some embodiments, the payment identifier is identical to the order identifier.

Referring to the payment information, in some embodiments, the payment information can be received from any entity capable of receiving payment information from the user, such as a PoS device processing credit/debit card information, for example. The payment information can include one or more of the following: user information, a mode of payment, an amount of payment, tax information, a timestamp associated with the payment, a location identifier for where the payment is made, any applicable discounts, a merchant identifier (MID) of the merchant 150, a store identifier (SID), a terminal identifier (TID) of the PoS device, and/or the like.

As described above, while the user can pay for the purchase at the PoS device, and possibly even receive a receipt at the PoS device that includes information about the purchase, the PoS device does not accept or transmit information about the purchase. Hence, in some embodiments, the payment information does not identify the purchase. Further, existing PoS devices do not accept or transmit information about the first user account that was associated with the order. Hence, in some embodiments, the payment information does not identify the first user account.

In some embodiments, the payment information includes a unique payment identifier. Alternatively, the payment identifier can be generated based on the received payment information. In some embodiments, the payment identifier is the same as, or a function of one or more of: a prepaid/gift/credit/debit card number, an email address, a cell phone number, social media credentials, a Near Field Communications (NFC) identifier, an identifier provided by the user, an identifier generated and/or provided by the system receiving the payment, and/or the like. In some embodiments, the payment identifier can be the same as, or generated based on, the combination of a payment amount, a payment location, and a payment timestamp.

In some embodiments, at least a portion of the payment information is encrypted. In some embodiments, the payment information includes a token which is associated with a portion of the payment information that is considered sensitive (e.g. a credit card number). For example, a PoS device of the merchant receiving the payment information can replace the sensitive information with the token, and to transmit the token as part of the payment information.

In some embodiments, the payment information is associated with the purchase by matching the payment information to the order information for the purchase. Any aspect of the payment information and the order information can be used for this purpose, and matching is not limited to finding an exact match, but generally includes a finding of any relationship that can accurately correlate the order information and the payment information. In some embodiments, the matching is performed based on the payment identifier of the payment information and the order identifier of the order information, and/or any part thereof. For example, in some embodiments, a match is determined when the order amount of the order identifier matches the payment amount of the payment identifier. In this manner, when the order is based on a unique price offering by the merchant, a match can be determined by this approach alone. As another example, in some embodiments, a match is determined when the payment location is at a merchant associated with the order location, such as when a merchant is running an ad campaign at the order location. As yet another example, a matched is determined when the payment timestamp is within a specified time of the order timestamp, i.e. within a timeout value. In some embodiments, any combination of these or other aspects of the order information and payment information can be employed for matching.

In some embodiments, the payment information can include a payment token as described earlier, and a match can be determined based on the payment token as described herein. Since the payment token uniquely identifies a payment means (e.g. a credit card number) which in turn is uniquely associated with the user, the payment token can be used to access an account of the user that links the payment token to the user account. Once the user account is determined, it can be used to determine order information that has the same user account associated therewith. In other words, the payment token also serves as a payment identifier. In some embodiments, the linking account can be a loyalty account of the user that can be used to determine discount information to be included in the transaction information. In other words, aspects of this disclosure can operate within the context of a system for providing real-time loyalty discounts as disclosed in co-pending U.S. patent application Ser. No. 13/793,061, entitled, “SYSTEM AND METHOD FOR PROVIDING REAL-TIME LOYALTY DISCOUNTS AND PAPERLESS RECEIPTS”, filed on Mar. 11, 2013, the disclosure of which is incorporated in its entirety herein by reference (“the Real-Time Loyalty application”).

Once a match is determined between the order information and the payment information for the purchase, transaction information can be determined and generated for the purchase. The transaction information can include any portion of the order information and/or the payment information. In some embodiments, the transaction information can include discount information to be applied to the payment amount. In some embodiments, the discount information can be determined by accessing a loyalty account of the user based on the user account (i.e. the transaction information includes the user account). For example, the loyalty account can be associated with a rewards program, and can have discount information associated therewith that can be applied to reduce the payment amount. In some embodiments, the discount information can be updated to reflect the purchase (see the Real-Time Loyalty application for more details).

In some embodiments, the discount information can be determined based on the payment token. Since the payment token can uniquely identify the user, in some embodiments, the discount information can be determined by accessing a loyalty account of the user based on the payment token (i.e. the transaction information includes the payment token). The discount information associated with the loyalty account can then be determined and/or updated as described earlier.

In this manner, discount information can be determined based on the user account and/or the payment token. Aspects of the systems and methods described herein are hence operable in environments where the order information can be missing and/or is unable to provide the user account information, and in stricter security settings where the payment information removes any indication of the payment means (i.e. no payment token is provided).

Aspects of the systems and methods described herein are further operable to apply discounts to transactions where the loyalty account is associated with the user account of the order information but not the payment token of the matched payment information. In such scenarios, it can be deemed that the purchase is by a previously registered/pending user of the loyalty account (see the Real-Time Loyalty application for more details), and the user can still avail of the discount by providing no additional information during payment, despite paying with a new payment means.

Once transaction information is determined, at least a portion of it can be transmitted to the user, such as to the first user account for example. In some embodiments, the transaction information can specify discount information applied to the payment amount. In this manner, the user can receive a digital/paperless receipt at the first user account where the order was placed. For example, if the first user account is a social media account, the user can claim a merchant's offer via the social media account, and receive a receipt that is displayed on the user's social media account, which can include discount information. The merchant is benefitted by the visibility of the receipt and discount benefits to the user's social media friends.

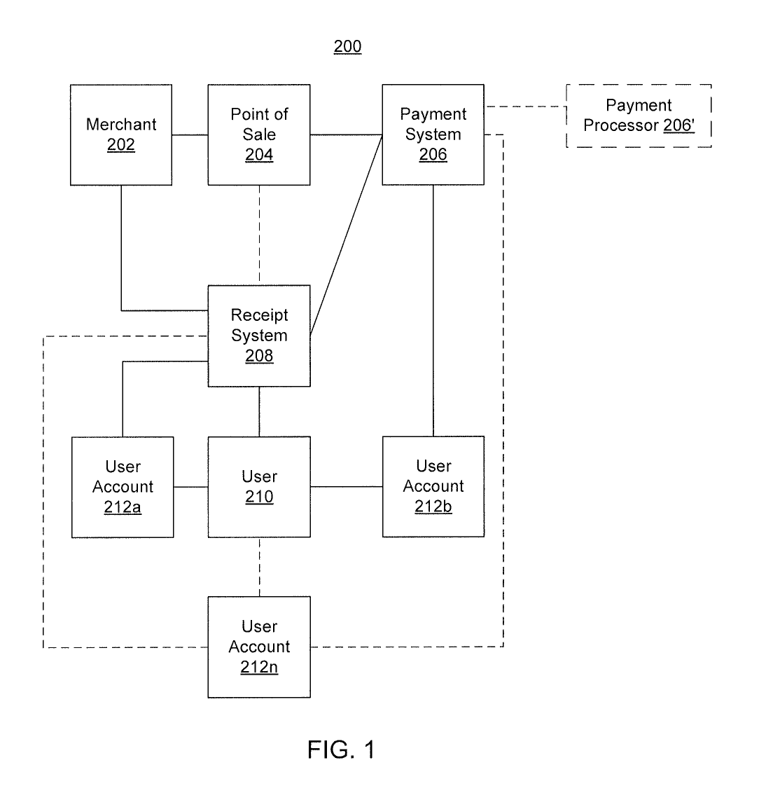

In some embodiments, once transaction information is determined, at least a portion of it, as required for executing the payment for the purchase, can be transmitted directly to a payment service provider (PSP) for processing. The payment service provider can be selectable by the merchant of the purchase. Hence, in some embodiments, aspects of this disclosure can operate within the context of a payment service provider management system as disclosed in co-pending U.S. patent application Ser. No. 13/793,549, entitled, “SYSTEM AND METHOD OF A PROVIDER MANAGEMENT SYSTEM”, filed on Mar. 11, 2013, the disclosure of which is incorporated in its entirety herein by reference (“the Provider Management application”). In some embodiments, the payment information is received from a PSP and/or another payment system that suspends the payment information, pending determination of transaction information. In such embodiments, once transaction information is determined, at least a portion of the transaction information is transmitted to the payment system for processing, which in turn releases the suspended payment information. In some embodiments, the transmitted portion of the transaction information includes at least the discount information. FIG. 1 illustrates an environment or system 200 within which aspects of the method can be implemented. The system 200 is operable for determining transaction information for a purchase. In some embodiments, the system 200 also determines and applies discount information to the purchases. In some embodiments, the system 200 is operable for use by a merchant 202 having an associated point of sale (PoS) device 204 to receive payment for the purchase, where the user 210 places the order for the purchase via a user account such as a social media account (e.g. user account 212a) of the user. Generally, the user 210 may be associated with additional user accounts as well (e.g. user accounts 212b, 212n).

The system 200 includes a receipt system 208 and a payment system 206. The payment system 206 can optionally encompass or (as illustrated) be in communication with a payment processor 206′. The various components of the system 200 can be in communication as indicated by lines in FIG. 1 via a network, which may be any type of network (e.g., a local area network or LAN, a wide area network or WAN, a virtual network, a telecommunications network, and/or the internet) implemented as a wired network and/or a wireless network. Any or all communications may be secured (e.g., encrypted) or unsecured, as is known in the art. Each of the merchant 202, point-of-sale (PoS) 204, payment system 206, payment processor 206′, receipt system 208, and user 210 can include a personal computer, a server, a work station, a tablet, a mobile device, a cloud computing environment, an application or a module running on any of these platforms, and/or the like. Additionally, it is understood that merchant 202 and user 210 can be any suitably representative human entity, such as an actual person, an employee, and so on. Hence, user accounts 212a, 212b, 212n and so on might be that of a person depicted as user 210, and not necessarily tied to a device corresponding to the user 210.

Unless explicitly stated otherwise, it is understood that all components, systems, and modules of the system 200 can encompass the functionality of similarly named components, systems and modules of the Real-Time Loyalty application and the Provider Management application.

In some embodiments, at least some aspects of the payment system 206 and the receipt system 208 are commonly implemented on the same device, and/or are commonly owned. In some embodiments, the payment processor 206′ is a third party service for executing payments.

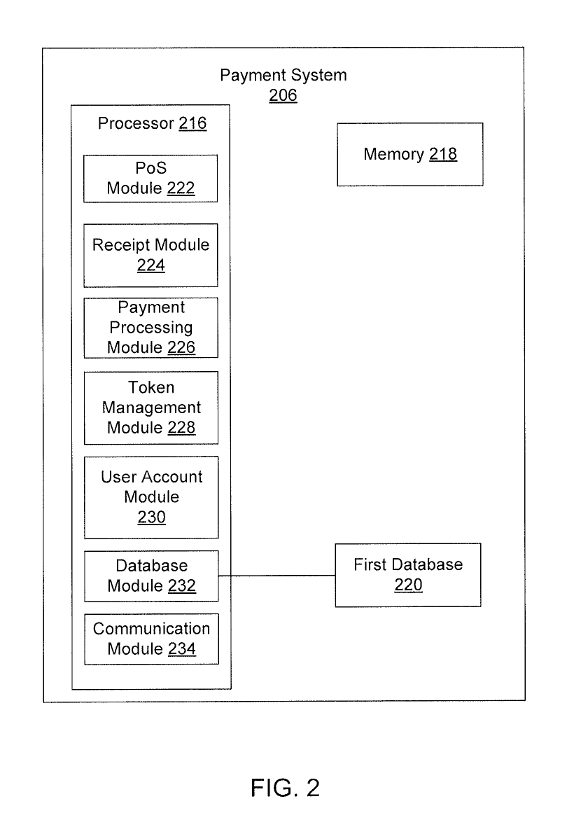

FIG. 2 illustrates the payment system 206 according to some embodiments. The payment system 206 includes at least a processor 216 and a memory 218. The payment system 206 may additionally include a first database 220, although it is understood that the first database 220 can be outside the device/system context of the payment system 206 (yet within the system 200) while still accessible and usable by the payment system. In some embodiments, the memory 218 includes the first database 220. The processor 216 can include a point of sale (PoS) module 222, a receipt module 224, a payment processing module 226, a token management module 228 and a user account module 230. The processor 216 can also include a database module 232 for reading and/or updating the first database 220. The processor 216 can also include a communications module 234 for establishing and managing network connectivity of the payment system 206 within the system 200. The functionality of each of the modules of the payment system 206 is provided in great detail in the Real-Time Loyalty application and the Provider Management application, and will not be discussed further here.

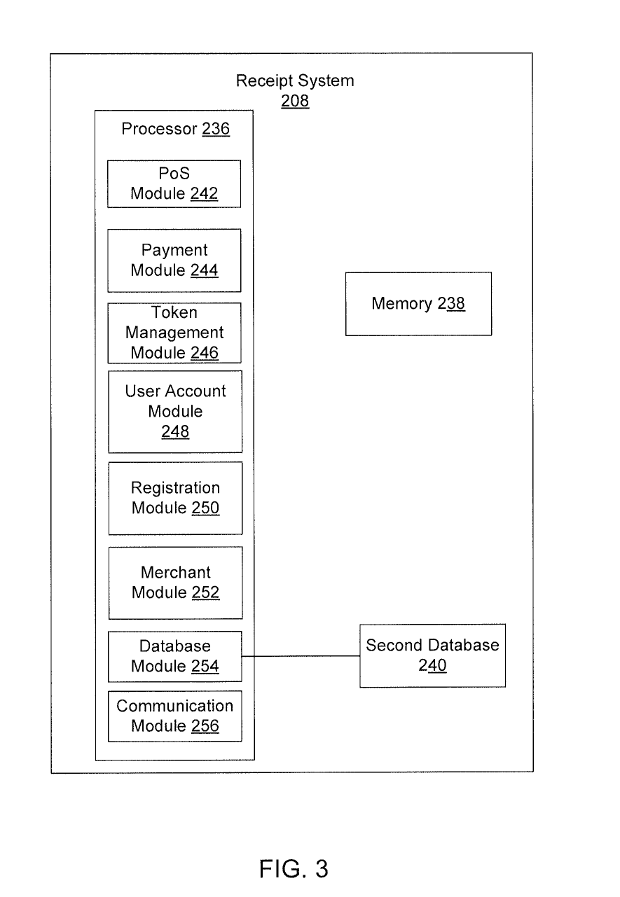

FIG. 3 illustrates the receipt system 208 according to some embodiments. The receipt system 208 includes at least a processor 236 and a memory 238. The receipt system 208 may additionally encompass a second database 240, although it is understood that the second database 240 can be outside the device/system context of the receipt system 208 (yet within the system 200) while still accessible and usable by the receipt system. In some embodiments, the memory 238 includes the second database 240.

The processor 236 can include a point of sale (PoS) module 242, a payment module 244, a token management module 246, a user account module 248, a registration module 250, and a merchant module 252. The processor 236 can also include a database module 254 for reading and/or updating the second database 220. The processor 236 can also include a communications module 254 for establishing and managing network connectivity of the receipt system 208 within the system 200. The functionality of the various modules of the processor 236 can overlap, and/or two or more modules can be combined. Furthermore, each of the modules may be in seamless communication with each other module.

The PoS module 242 of the receipt system 208 can be configurable to receive data directly from the PoS 204 and/or from the merchant 202, as best illustrated in FIG. 1. In this manner, the receipt system 208 can receive less sensitive payment information from the merchant directly from the PoS 204, and relatively more sensitive payment information, such as the payment token, via the payment system 206. Examples of less sensitive transaction information include, but is not limited to, a stock keeping unit (SKU), and/or the like. In some embodiments, the PoS module 242 communicates transaction and non-transaction related information to the PoS 204, such as advertisements, registration information, product ratings, and/or the like. In some embodiments, the PoS module 242 and the receipt system 206 are commonly owned or otherwise permitted to directly communicate as described here. In other embodiments, the PoS 204 is a third party device with respect to the receipt system 206, and cannot communicate with the receipt system. Hence, the PoS module 242 can be optional.

The user account module 248 can be configured to receive order information associated with a user account (e.g. the user account 212a), where the order information is associated with a purchase by the user. The user account can be one or more of an online account, a social media account, an email account, a phone number, and/or the like. The user account module 248 can be further configured to transmit the order information to the token management module 246. The user account module 248 can be further configured to receive transaction information from the token management module 246, and transmit at least a portion of the transaction information (e.g. as a paperless receipt) to the user account. In some embodiments, the transmitted portion of the transaction information includes a receipt for the purchase, and optionally includes discount information associated with the transaction information. In some embodiments, the user account module 248 is configurable to determine the user account based on the payment token. In some embodiments, and as described in greater detail in the Real-Time Loyalty application, the user account module 248 can be configured to manage the registration data of users.

The payment module 244 can be configured to receive the payment information from the payment system 206. In some embodiments, the payment information does not identify the purchase, and does not identify the user account. In some embodiments, the payment module 244 can be configured to communicate the payment information to the token management module 246, and to receive transaction information from the token management module 246. The payment module 244 can be further configured to transmit at least a portion of the transaction information to the payment service provider 206′ for processing (i.e. via the payment system 206). In some embodiments, the payment system 206 has suspended the payment information, and the payment module 244 transmitting the portion of the transaction information to the payment system 206 for processing releases the suspended payment information.

The token management module 246 can be configured to determine that the payment information is associated with the purchase, and to determine transaction information associated with the purchase based on the order information and based on the payment information. In some embodiments, the payment information includes a payment identifier, and the token management module 246 can be configured to determine that the payment information is associated with the purchase by determining a loyalty account associated with the payment identifier, and matching the payment information to the order information based on the user account, thereby determining that the payment information is associated with the purchase. The loyalty account is associated with the user account.

In some embodiments, the order information includes an order identifier and the payment information includes a payment identifier, and the token management module 246 is further configured to determining that the payment information is associated with the payment by matching the order identifier to the payment identifier.

In some embodiments, the token management module 246 is further configured to generate an order identifier based on the order information, where the order identifier includes one or more of the following: an order amount, an order location, and an order timestamp. In some embodiments, the token management module 246 is further configured to generate a payment identifier based on the payment information, where the payment identifier includes one or more of the following: a payment amount, a payment location, and a payment timestamp. In some embodiments, the token management module 246 is further configured to determining that the payment information is associated with the purchase by matching the order identifier to the payment identifier by determining a match between one or more of the following pairs: the order amount and the payment amount, the order location and the payment location, the order timestamp and the payment timestamp.

In some embodiments, the token management module 246 is further configured to match the order identifier to the payment identifier by determining a match between the order timestamp and the payment timestamp based on a timeout value. In some embodiments, the token management module 246 is further configured to determine the transaction information by applying the discount to the transaction information.

The merchant module 252 can be configured to determine a discount based on the transaction information and based on the user account. In some embodiments, the merchant module is further configured to determine the discount by accessing a loyalty account associated with the user account, where the loyalty account has discount information associated therewith. The discount is determined based on the discount information and based on the transaction information. The discount information can be updated based on the transaction information.

In some embodiments, the transaction information includes a payment token, the payment token based on the payment information. The merchant module 252 can be further configured to determine a discount based on the transaction information and based on the payment token.

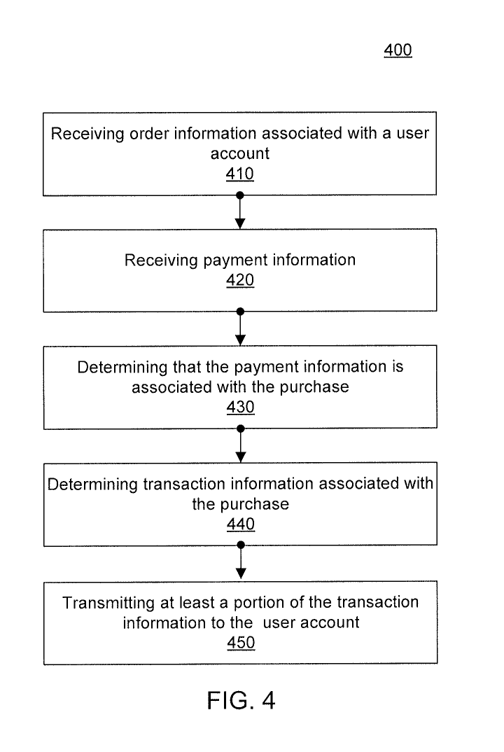

FIG. 4 illustrates a method 400 of generating transaction information for a purchase. In some embodiments, computer readable storage media stores computer executable instructions for implementing the method 400. At 410, order information is received that is associated with a user account, and is associated with a purchase. At 420, payment information is received, where the payment information does not specify the user account, and does not identify the purchase. At 430, it is determined that the payment information is associated with the purchase. At 440, transaction information is determined that is associated with the purchase based on the order information and based on the payment information. At 450, at least a portion of the transaction information is transmitted to the user account.

For simplicity, the system 200 and the method 400 are described with respect to a single customer transaction arising from a single order for a purchase and a single payment for the purchase. It will be understood, as is typical, that multiplicity of any of these aspects is within the scope of the disclosure: multiple orders (i.e. order information) and payments (i.e. payment information) can exist that are matched. Multiple orders can match a single payment, multiple payments can be made for the same order (e.g. via multiple gift cards), multiple user accounts may receive the transaction information, and so on. In this manner, orders generated and fulfilled at disparate locations or devices can be combined and provided to any of the parties involved in the transaction, e.g. the merchant and/or the user.

Aspects of the systems and methods described herein permit a user to be recognized when paying for a purchase at a separate location from the order location, no matter what the payment means of the user is. Further, the user can still avail discounts for the purchase no matter what the payment means is, as long as the user has a loyalty account associated with the user account used to place the order.

Merchants are benefitted by being able to use varied marketing tools, such as social media, without losing track of the effectiveness of such marketing, since payments can be electronically tied to orders placed via such marketing tools, and the user can be provided discount benefits, thereby promoting user loyalty towards the merchant. Further, the merchant can issue high-visibility digital receipts directly to a user's social media account, which has further marketing benefits for the merchant.

In some embodiments described herein, a computer storage product with a non-transitory computer-readable medium (also referred to as a non-transitory processor-readable medium) has instructions or computer code thereon for performing various computer-implemented operations. The computer-readable medium (or processor-readable medium) is non-transitory in the sense that it does not include transitory propagating signals (e.g., a propagating electromagnetic wave carrying information on a transmission medium such as space or a cable). The media and computer code (also referred to herein as code) may be those designed and constructed for the specific purpose or purposes. Examples of non-transitory computer-readable media include, but are not limited to: magnetic storage media such as hard disks, optical storage media such as Compact Disc/Digital Video Discs (CD/DVDs), Compact Disc-Read Only Memories (CD-ROMs), magneto-optical storage media such as optical disks, carrier wave signal processing modules, and hardware devices that are specially configured to store and execute program code, such as Application-Specific Integrated Circuits (ASICs), Programmable Logic Devices (PLDs), Read-Only Memory (ROM) and Random-Access Memory (RAM) devices.

Examples of computer code include, but are not limited to, micro-code or micro-instructions, machine instructions, such as produced by a compiler, code used to produce a web service, and files containing higher-level instructions that are executed by a computer using an interpreter. For example, embodiments may be implemented using Java, C++, or other programming languages and/or other development tools.

The various embodiments described herein should not to be construed as limiting this disclosure in scope or spirit. It is to be understood that no limitation to the scope of the disclosure is intended thereby. It is to be further understood that resort may be had to various other embodiments, modifications, and equivalents thereof which may suggest themselves to those skilled in the art without departing from the spirit of the present disclosure and/or scope of the appended claims.

Those skilled in the art will recognize, or be able to ascertain, using no more than routine experimentation, numerous equivalents to the specific embodiments described specifically herein. Such equivalents are intended to be encompassed in the scope of the following claims.

1. A method of determining transaction information for a purchase, comprising:
receiving order information associated with a user account, the order information associated with a purchase;
receiving payment information, wherein the payment information does not identify the purchase, and wherein the payment information does not identify the user account;
determining that the payment information is associated with the purchase;
determining transaction information associated with the purchase based on the order information and based on the payment information; and
transmitting at least a portion of the transaction information to the user account.

2. The method of claim 1, wherein the payment information includes a payment identifier, the determining that the payment information is associated with the purchase comprising:
determining a loyalty account associated with the payment identifier, the loyalty account associated with the user account; and
matching the payment information to the order information based on the user account, thereby determining that the payment information is associated with the purchase.

3. The method of claim 1, wherein the order information includes an order identifier, wherein the payment information includes a payment identifier, and wherein the determining that the payment information is associated with the payment includes matching the order identifier to the payment identifier.

4. The method of claim 1, further comprising generating an order identifier based on the order information, wherein the order identifier includes one or more of the following: an order amount, an order location, and an order timestamp.

5. The method of claim 4, further comprising generating a payment identifier based on the payment information, wherein the payment identifier includes one or more of the following: a payment amount, a payment location, and a payment timestamp.

6. The method of claim 5, the determining that the payment information is associated with the purchase includes matching the order identifier to the payment identifier by determining a match between one or more of the following pairs: the order amount and the payment amount, the order location and the payment location, the order timestamp and the payment timestamp.

7. The method of claim 6, wherein matching the order identifier to the payment identifier includes determining a match between the order timestamp and the payment timestamp based on a timeout value.

8. The method of claim 6, wherein the transaction information includes the user account, the determining the transaction information further comprising:
determining a discount based on the transaction information and based on the user account; and
applying the discount to the transaction information.

9. The method of claim 8, the determining the discount comprising:
accessing a loyalty account associated with the user account, the loyalty account having discount information associated therewith;
determining the discount based on the discount information and based on the transaction information; and
updating the discount information based on the transaction information.

10. The method of claim 1, wherein the transaction information includes the user account, the determining the transaction information further comprising:
determining a discount based on the transaction information and based on the user account; and
applying the discount to the transaction information.

11. The method of claim 10, the determining the discount comprising:
accessing a loyalty account associated with the user account, the loyalty account having discount information associated therewith;
determining the discount based on the discount information and based on the transaction information; and
updating the discount information based on the transaction information.

12. The method of claim 1, wherein the transaction information includes a payment token, the payment token based on the payment information, the determining the transaction information further comprising:
determining a discount based on the transaction information and based on the payment token; and
applying the discount to the transaction information.

13. The method of claim 12, the determining the discount comprising:
accessing a loyalty account associated with the payment token, the loyalty account having discount information associated therewith;
determining the discount based on the discount information and based on the transaction information; and
updating the discount information based on the transaction information.

14. The method of claim 1, wherein the transaction information includes a payment token, the payment token based on the payment information, wherein the transaction information does not include the user account, the transmitting comprising determining the user account based on the payment token.

15. The method of claim 1, wherein the user account is one or more of the following: an online account, a social media account, an email account and a phone number.

16. The method of claim 1, wherein the transmitted portion of the transaction information includes a receipt for the purchase, and optionally includes discount information associated with the transaction information.

17. The method of claim 1, further comprising transmitting at least a portion of the transaction information to a payment service provider for processing.

18. The method of claim 1, wherein the payment information is suspended payment information, further comprising transmitting, in response to receiving the payment information, at least a portion of the transaction information to a payment system for processing, thereby releasing the suspended payment information.

19. A computer readable storage media storing computer executable instructions for implementing the method of claim 1.

20. A system for determining transaction information for a purchase comprising a processor, the processor further comprising:
a user account module configured to receive order information associated with a user account, the order information associated with a purchase;
a payment module configured to receive payment information, wherein the payment information does not identify the purchase, and wherein the payment information does not identify the user account; and
a token management module configured to:
determine that the payment information is associated with the purchase; and
determine transaction information associated with the purchase based on the order information and based on the payment information,
wherein the user account module is further configured to transmit at least a portion of the transaction information to the user account.

21.-37. (canceled)
